(19) United States
(12) Patent Application Publication
(10) Pub. No.: US 2018/0155096 A1
(43) Pub. Date: Jun. 7, 2018

(54) LID WITH REMOVABLE BOTTLE OPENER AND BEVERAGE CONTAINER INCLUDING THE LID

(71) Applicant: Danhong Pan, Shanghai (CN)

(72) Inventor: Danhong Pan, Shanghai (CN)

(73) Assignee: POLYCONCEPT NORTH AMERICA, INC., New Kensington, PA (US)

(21) Appl. No.: 15/367,294

(22) Filed: Dec. 2, 2016

(51) Int. Cl. B65D 51/24; A47G 19/22; B65D 43/02; B65D 53/02; B65D 81/38; B67B 7/16

(52) U.S. Cl. CPC B65D 51/243; A47G 19/2272; B67B 7/16; B65D 53/02; B65D 81/3865; B65D 43/0225

(57) ABSTRACT

A lid which includes a removable bottle opener and a beverage container including the lid are disclosed. The lid includes a lid surface having a receiving slot that receives the bottle opener, a circumferential wall which surrounds the lid surface and engages an open end of a beverage container, and a port that is sized and shaped for passage of a liquid, the port passing through the lid surface and positioned proximal to the circumferential wall of the lid within the receiving slot. The bottle opener includes an opening at a distal end which is sized and shaped to open a cap of a bottle. The bottle opener is slidingly received in the receiving slot of the lid surface so that a proximal end of the bottle opener covers the port and impedes passage of the liquid therethrough.

### TECHNICAL FIELD OF THE INVENTION

This invention pertains generally to a lid for a beverage container, and more specifically, a lid which includes a removable bottle opener, and a beverage container including the lid.

### BACKGROUND OF THE INVENTION

Portable insulated beverage containers having sealable drinking ports are known in the art and are in common use around the world to transport beverages such as hot coffee during a morning commute, or cold beer during an outdoor picnic. Drinking ports covered by sliding members which open/close to provide access to the drinking port are also known in the art. Containers combining these aspects provide a means to transport hot or cold beverages, and to operate a cover for the drinking port so that the beverage is not spilled during transport but is accessible when desired.

These containers are often filed with beverages purchased while away from home, such as on the morning commute. Many beverage bottles are covered by caps that are not easily opened by hand, such as the crimped caps found on glass beer and soda bottles. Such caps often require the use of a bottle opened to pry the cap from the bottle. When enjoying these drinks, however, a bottle opener is not always available. Further, twist-off caps, stay-on-tabs, and pull-tabs, while designed to be easily opened by hand, are often difficult to open for people with poor or reduced manual dexterity or strength.

What is needed is a readily available means to open such bottles so that their contents may be transferred to a portable beverage container, and may thus be kept warm or cold and may be easily transported.

### SUMMARY OF THE INVENTION

The present invention offers a solution by providing a lid for a beverage container, wherein the lid includes a removable bottle opener. The removable bottle opener may be integrated as a slidable seal for a drinking port on the lid. As such, a bottle opener is always at hand and is provided as part of a portable drinking vessel that may be easily opened with one hand.

Thus, the presently disclosed invention provides a lid for a beverage container, wherein the lid includes a removable bottle opener. The bottle opener is generally defined as having a proximal end, a distal end, and a longitudinal axis therebetween, and comprises an opening at the distal end which is sized and shaped to open a cap of a bottle. The lid is generally defined as comprising a lid surface having a top side which comprises a receiving slot configured to receive the bottle opener, a circumferential wall surrounding the lid surface and configured to sealingly engage with an open end of a beverage container, and a port that is of a size and shape appropriate for passage of a liquid, the port passing from the top side of the lid surface to a bottom side of the lid surface and positioned proximal to the circumferential wall of the lid within the receiving slot. The bottle opener is slidingly received in the receiving slot of the top side of the lid surface so that the proximal end of the bottle opener covers the port and stops passage of the liquid therethrough.

The presently disclosed invention further comprises a beverage container which includes the lid with the removable bottle opener.

### BRIEF DESCRIPTION OF THE DRAWINGS

Aspects, features, benefits and advantages of the embodiments herein will be apparent with regard to the following description, appended claims, and accompanying drawings. In the following figures, like numerals represent like features in the various views. It is to be noted that features and components in these drawings, illustrating the views of embodiments of the present invention, unless stated to be otherwise, are not necessarily drawn to scale.

FIG. 1 illustrates a perspective view of a beverage container including a lid in accordance with certain aspects of the present invention;

FIG. 2A illustrates a front elevation view of the beverage container including the lid shown in FIG. 1;

FIG. 2B illustrates a right side elevation view of the beverage container including the lid shown in FIG. 1;

FIG. 2C illustrates a left side elevation side view of the beverage container including the lid shown in FIG. 1;

FIG. 3A illustrates a rear elevation view of the beverage container including the lid shown in FIG. 1;

FIG. 3B illustrates a cross-sectional view taken along line 3B-3B of the beverage container including the lid shown in FIG. 2B;

FIG. 4A illustrates a top view of the beverage container including the lid shown in FIG. 1;

FIG. 4B illustrates a bottom view of the beverage container including the lid shown in FIG. 1;

FIG. 5 illustrates a side perspective view of the lid including a bottle opener in accordance with certain aspects of the present invention;

FIG. 6A illustrates a top perspective view of the lid shown in FIG. 5 with the bottle opener removed;

FIG. 6B illustrates a bottom perspective view of a bottle opener in accordance with certain aspects of the present invention; and

FIGS. 7A-7E illustrate a bottle opener being slidingly removed from the receiving slot of the lid in accordance with certain aspects of the present invention, wherein FIG. 7A illustrates the bottle opener fully received within the receiving slot and covering the dinking port, FIG. 7B illustrates the bottle opener partially removed from the receiving slot to expose the drinking port, FIG. 7C illustrates the bottle opener nearly fully removed from the receiving slot to fully expose the opening of the bottle opener, FIG. 7D illustrates the lid with the bottle opener fully removed, and FIG. 7E illustrates the bottle opener removed from the lid.

### DETAILED DESCRIPTION

In the following description, the present invention is set forth in the context of various alternative embodiments and implementations involving a lid comprising a removable bottle opener and a beverage container comprising the lid. The lid includes a receiving slot that slidingly receives the bottle opener. The lid further comprises a drinking port that may be opened or closed by the sliding action of the bottle opener within the receiving slot.

Various aspects of the beverage container and lid may be illustrated by describing components that are coupled, attached, and/or joined together. As used herein, the terms “coupled”, “attached”, and/or “joined” are interchangeably used to indicate either a direct connection between two components or, where appropriate, an indirect connection to one another through intervening or intermediate components. In contrast, when a component is referred to as being “directly coupled”, “directly attached”, and/or “directly joined” to another component, there are no intervening elements shown in said examples.

Various aspects of the beverage container and lid may be illustrated with reference to one or more exemplary implementations. As used herein, the term “exemplary” means “serving as an example, instance, or illustration,” and should not necessarily be construed as preferred or advantageous over other variations of the devices, systems, or methods disclosed herein. “Optional” or “optionally” means that the subsequently described event or circumstance may or may not occur, and that the description includes instances where the event occurs and instances where it does not. In addition, the word “comprising” as used herein means “including, but not limited to”.

Furthermore, throughout the specification, reference to “one embodiment,” “an embodiment,” or “some embodiments” means that a particular described feature, structure, or characteristic is included in at least one embodiment. Thus, appearances of the phrases “in one embodiment,” “in an embodiment,” or “in some embodiments” in various places throughout this specification are not necessarily all referring to the same embodiment. Those skilled in the art will recognize that the various embodiments detailed herein can be practiced without one or more of the specific details or with other methods, components, materials, etc. In other instances, well-known structures, materials, or operations are not shown or not described in detail to avoid obscuring aspects of the embodiments.

Relative terms such as “lower” or “bottom” and “upper” or “top” may be used herein to describe one element's relationship to another element illustrated in the drawings. It will be understood that relative terms are intended to encompass different orientations of aspects of the beverage container and lid in addition to the orientation depicted in the drawings. By way of example, if aspects of the lid shown in the drawings are turned over, elements described as being on the “bottom” side of the other elements would then be oriented on the “top” side of the other elements as shown in the relevant drawing. The term “bottom” can therefore encompass both an orientation of “bottom” and “top” depending on the particular orientation of the drawing.

It must also be noted that as used herein and in the appended claims, the singular forms “a”, “an”, and “the” include the plural reference unless the context clearly dictates otherwise. Thus, for example, reference to “a” container, “a” lid, “a” tab, or “an” opener, is a reference to one or more of each and equivalents thereof known to those skilled in the art, and so forth.

Unless defined otherwise, all technical and scientific terms used herein have the same meanings as commonly understood by one of ordinary skill in the art.

Following is a description of the basic principles and functions of the present invention. Shown in the figures are illustrations of a beverage container 20 having a lid 10 engaged thereon, wherein the lid comprises a removable bottle opener 30. The combination of the beverage container, the lid, and the bottle opener is generally designated by reference number 100.

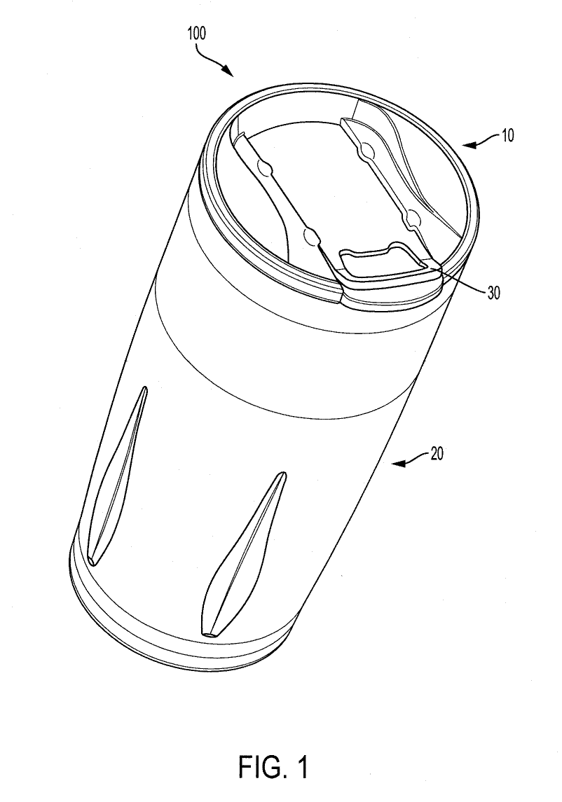

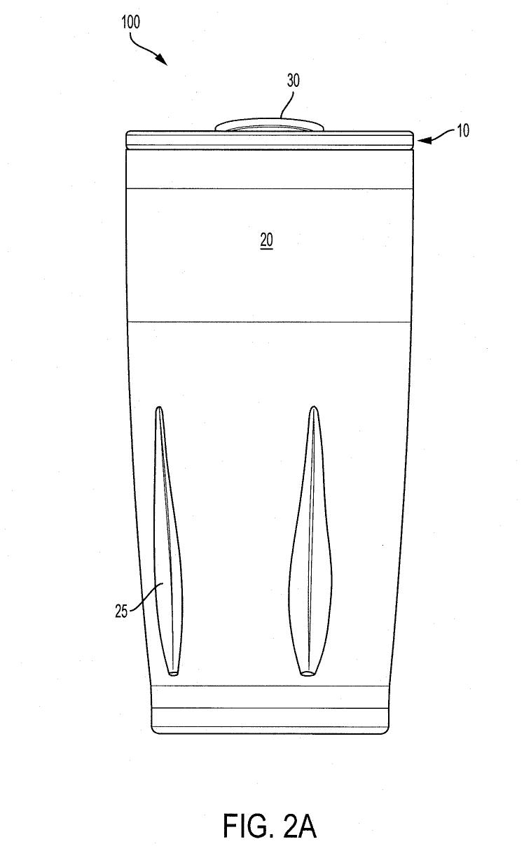

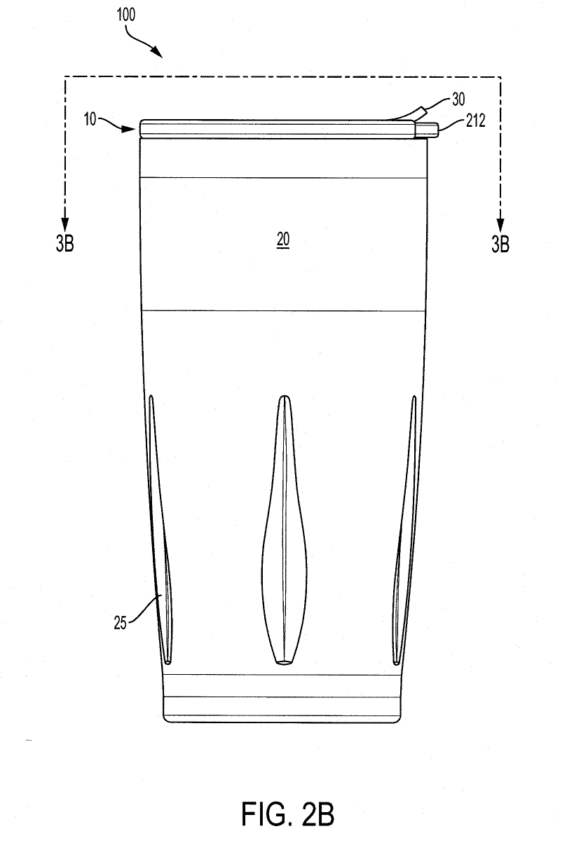

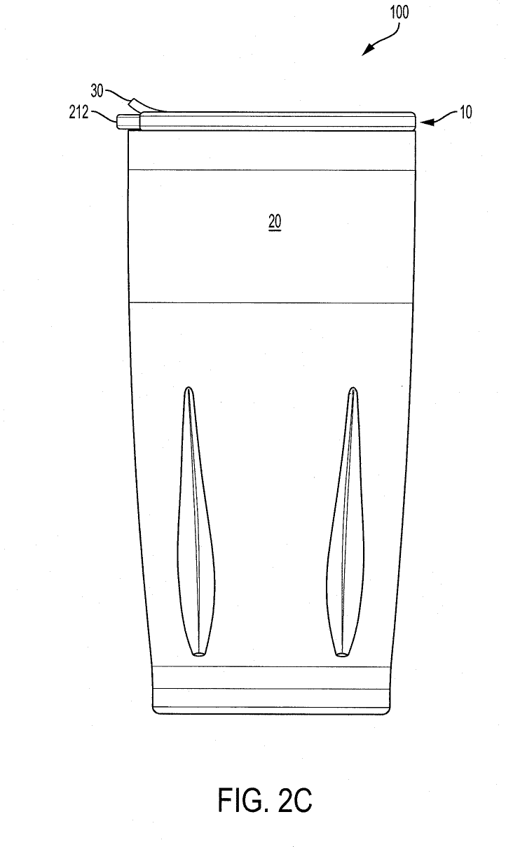

As shown in FIGS. 1 and 2A-2C, the combination 100 generally includes a reusable or durable beverage container 20, and a lid 10 which includes a removable bottle opener 30. As shown in FIG. 2A, which is a front elevation view of the combination 100, the main body of the beverage container 20 may include various features 25 that are configured to improve the grip characteristics of the container. As shown in FIGS. 2B and 2C, which are right and left side views of the combination 100, respectively, the lid 10 may include an extended region which projects outward from a circumference of the lid, or a lip 212, that may assist in removal of the lid 10 from the beverage container 20. Also shown is a distal end of the removable bottle opener 30, which extends upwardly away from a surface of the lid 10, over the lip 212.

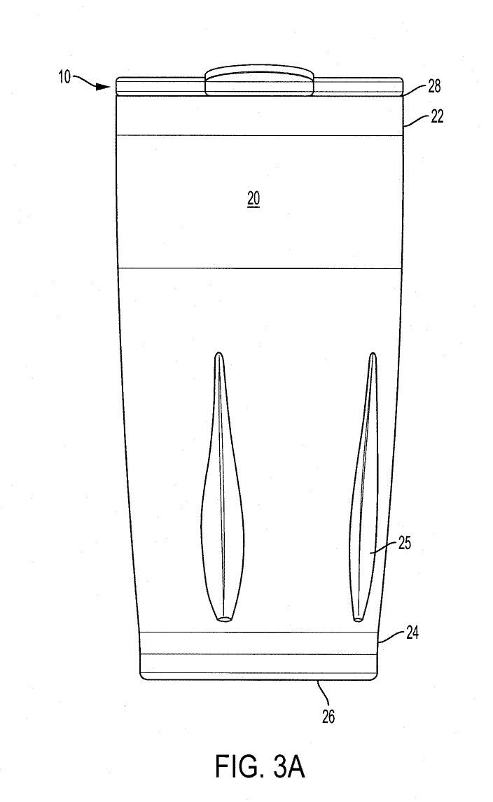

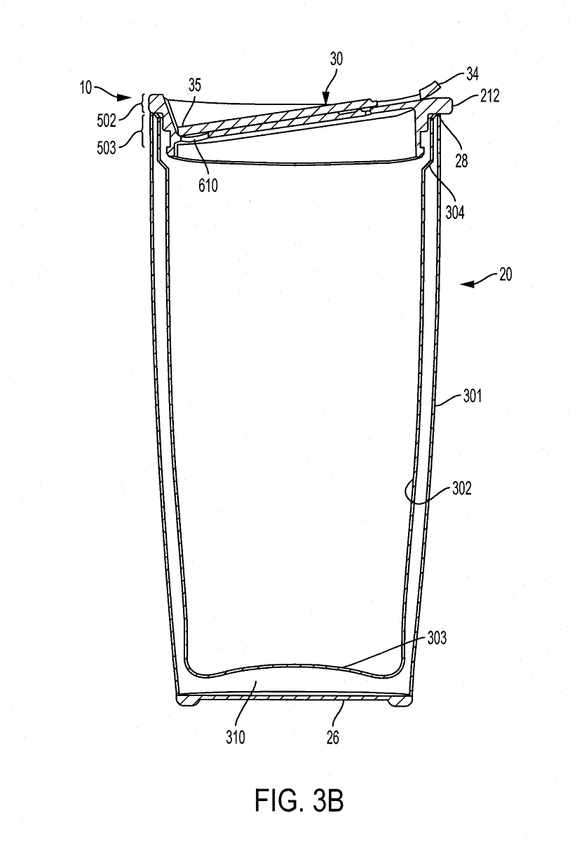

The beverage container 20, as further detailed in FIG. 3A, comprises a main body with an open top end 28 and a sealed bottom end 26 which define an inner cavity configured to hold a volume of liquid. The volume of liquid may vary, such as volumes of 6 to 64 ounces, or 8 to 36 ounces, or even 12 to 24 ounces. In size, the beverage container 20 may be generally suitable for being held with one hand, either by grasping an outer surface of the beverage container 20 or by grasping a handle (not shown) attached thereon.

Further, the beverage container 20 may be cylindrical, as shown in the figures, or may be of any shape convenient for use as a drinking vessel, such as ovoid, octagonal, hexagonal, etc. In general, the shape of the beverage container 20 may be suitable for being held with one hand, either by grasping the container 20 or a handle (not shown) attached thereon.

Although the beverage container 20 is generally shown as lacking a handle, a handle assembly may be included. For example, a handle assembly including an annular collar or rim and an integral, generally L-shaped handle, may be included. In such a case, the annular collar or rim may attach at an upper end 22 of the beverage container 20, or to a lower end 24 of the beverage container 20. Alternatively, a generally C-shaped handle may be directly attached at a top and bottom end thereof to an outer sidewall of the beverage container 20. While specific examples of handles and methods of attachment have been described, other types of handles and methods of attachment are known in the art and are within the scope of the present invention.

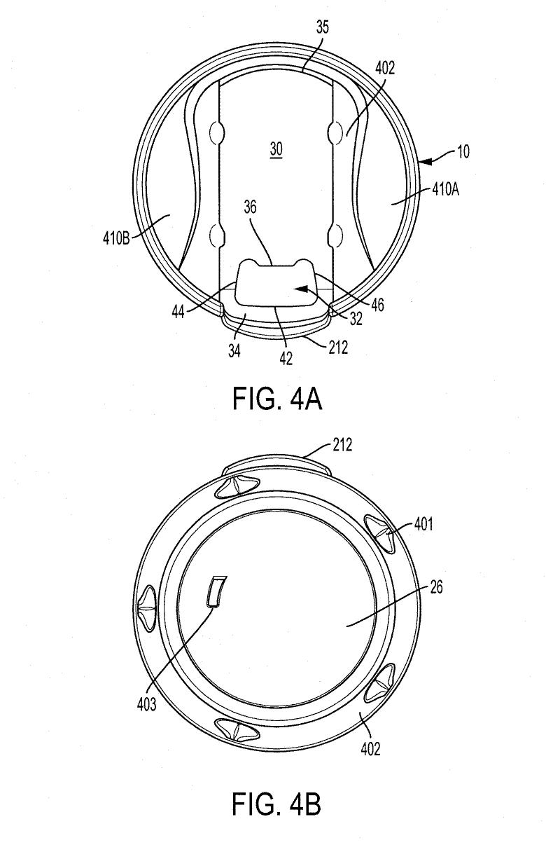

With specific reference to FIGS. 3A and 4B, the exterior of the beverage container 20 may comprise indented or raised features 25 which may improve the gripping characteristics of the container. Further, the bottom end 26 of the beverage container 20 may include raised or indented features 401 which may provide a non-skid base. These features (25 and/or 401) may comprise regions of the outer wall of the beverage container 20 that are textured, raised, or indented, or may be comprise separate elements that may be glued or otherwise affixed to the outer wall, such as rubber grips affixed in depressions that are formed in the outer wall.

The beverage container 10 may also include a rim 402 which is raised with respect to the remainder of the bottom end 26 of the beverage container to further assist in forming the non-skid base. That is, condensation that may collect at or near the bottom of the beverage container 20 will have a space to escape, reducing the risk of the beverage container 20 sliding from a surface on a film of liquid (condensation) formed thereon. Also shown in FIG. 4B is a notch 403 that may be used to help orient the beverage container 10 during production, such as for the proper positioning of labels, screen printing, etc.

With specific reference to FIG. 3B, the beverage container 20 may be thermally insulated. For example, the beverage container 20 may have an inner sidewall 302 having a base portion 303, and an outer sidewall 301 which provide an airspace 310 therebetween. This airspace 310 may be sealed, and may thus provide thermal insulation for a liquid contained within the cavity of the beverage container 20. Such sealing may be achieved, for example, by soldering, brazing, welding, epoxying, or co-forming the inner sidewall 302 and outer sidewall 301, depending on the material used to form the various sidewalls of the beverage container 20.

The air from the sealed airspace 310 may be partially evacuated prior to, at the same time as, or after sealing the inner and outer sidewalls (302 and 301, respectively). Such evacuation may be accomplished in any number of ways as are well known in the art such as, for example, by attaching a tube (not shown) to the outer sidewall 301 or the inner sidewall 302 to form a fluid connection to the airspace 310, using a vacuum pump to partially or fully evacuate the airspace 310, and then sealing the tube while maintaining the partial or full vacuum. Alternatively, the inner and outer sidewalls (302 and 301, respectively) may be sealed while the vessel is contained within a vacuum, thus forming a vacuum within the sealed sidewalls.

While the beverage container 20 is shown as having an inner sidewall 302 and an outer sidewall 301, additional layers are possible and are within the scope of the present invention. For example, the beverage container 20 may include an additional wall between the inner and outer sidewalls (302 and 301, respectively), wherein the space between the inner sidewall 302 and the additional wall may be evacuated, the space between the additional wall and the outer sidewall 301 may be evacuated, or both spaces may be evacuated.

Alternative to forming a vacuum in the sealed airspace 310, an inert gas such as, for example, helium or argon may be pumped into the space, or the airspace 310 may be sealed in an environment filled with an inert gas.

The beverage container 20 may be formed of a metal such as, for example, stainless steel, or another material, such as various plastics or glass. Further, the various sidewalls of the beverage container 20 may be formed of the same or different materials. For example, the other sidewall 301 may be formed of a metal while the inner sidewall 302 may be formed of a glass or polymeric material such as various plastics. A particularly suitable material for the beverage container 20, including both the inner sidewall 301 and the outer sidewall 302, is stainless steel, such as 18/8 grade stainless steel. Metal construction provides a rugged product that is generally able to withstand the occasional bumps and mishaps that may be expected, particularly for a transportable beverage container.

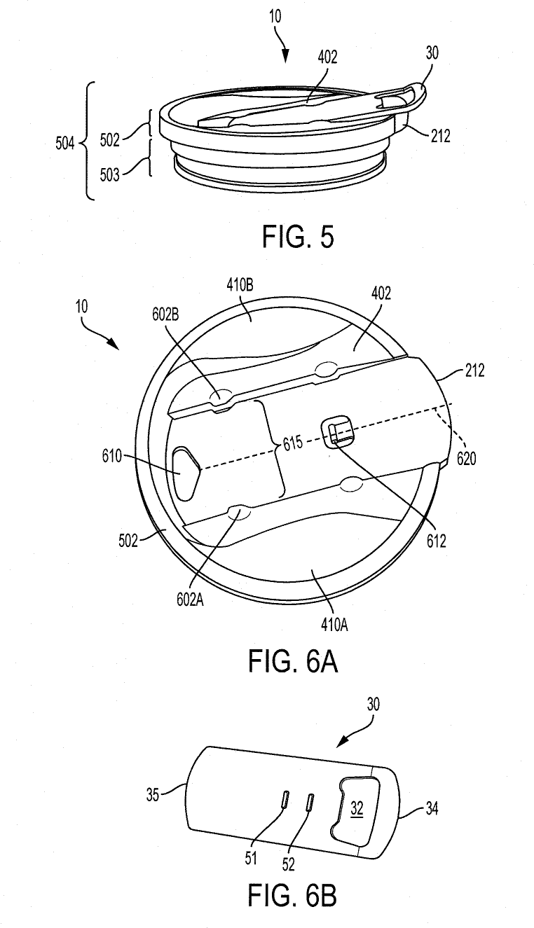

The combination 100 further comprises a lid 10, wherein a liquid contained within the beverage container 20 may be sealed therein from spilling by the lid 10. As shown in FIGS. 4A, 5 and 6A, the lid 10 generally comprises a lid surface 402 having a top side which comprises a receiving slot 615 configured to receive the bottle opener 30. The receiving slot may have a longitudinal axis 620 which aligns with a longitudinal axis of the bottle opener 30 when the bottle opener is received within the slot 615. With specific reference to FIGS. 2B and 5, the lid may comprise a circumferential wall 504 surrounding the lid surface 402. As shown, the circumferential wall 504 includes a top portion 502 and a base portion 503, wherein the base portion 503 is configured to sealingly engage with an open top end 28 of the beverage container 20.

As shown in FIG. 6A, the lid 10 may also comprise a port 610 which passes from the top side to a bottom side of the lid surface 402. The port 610 may be generally of a size and shape appropriate for passage of a liquid. Further, the port 610 may be positioned proximal to the circumferential wall 504 of the lid within a proximal end of the receiving slot 615. The receiving slot 615 may also include an extension or lip 212 at a distal end thereof. When viewed from the top, the lip 212 may extend beyond the circumferential wall 504, and may provide a resting position for a distal end 34 of the bottle opener 30 (see in FIG. 4A, wherein the bottle opener 30 is fully accepted in the receiving slot 615). As mentioned above, the lip 212 may assist in removal of the lid 10 from the beverage container 20, generally providing a leverage point to lift the lid from the beverage container (see in FIGS. 2B and 2C).

Also shown in FIG. 5 is the angled orientation of the top surface 402 of the lid 10 with respect to the circumferential side wall 504. That is, as shown in the figures, the top surface 402 of the lid 10 is nearly flush with the top portion 502 of the circumferential sidewall 504 at or proximal to the lip 212, at a position opposite from the port 610, and is angled downward toward the bottom portion 503 of the circumferential sidewall 504 along the side comprising the port 610. The downward angle is in a direction parallel with the longitudinal axis 620 of the receiving slot 615. This is more easily viewed in FIG. 3B which illustrates a cross-sectional view of the lid 10 having the bottle opener 30 received in the receiving slot 615. A distal end 35 of the bottle opener 30 is shown to cover the port 610 and a proximal end 34 of the bottle opener is shown to reside at or above the lip 212. The lid surface 402 can be seen to angle downward relative to the circumferential sidewall 504 of the lid 10, thus forming a small depression or trough in the lid 10.

This trough may be configured to allow liquid to flow into the area from the port 610 and form a sipping or drinking area adjacent to the port 610 (e.g., when the beverage container 20 and lid 10 are tilted/angled with respect to a horizontal plane). This sipping or drinking area may allow the user to sip a beverage as it collects in the trough, thus providing better control over the flow of the beverage (e.g., better control over a hot beverage to prevent burns). While this sipping or drinking area is shown as substantially planar (see FIG. 3B), this area could also be slightly curved (e.g., concavity) to allow for temporary pooling of the beverage. Further, raised regions (410A, 410B) may be included on sides of the trough to reduce the overall volume of the trough or drinking area.

Beyond forming a sipping or drinking trough in the lid 10, the downward angle of the lid surface 402, which is coincident with the longitudinal axis 620 of the receiving slot 615, may further assist in holding the bottle opener 30 on the lid 10.

The lid 10 and the bottle opener 30 may be composed of the same materials as the beverage container 20, or may each comprise a different material. A particularly suitable material for the lid 10 is a moldable polymeric material which may be opaque, or may be clear so that a beverage within the beverage container 20 may be viewed, such as an acrylic or styrene acrylonitrile (SAN) resin. A particularly suitable material for the bottle opener 30 may be a metal such as, for example, stainless steel (e.g., 18/8 grade stainless steel). The beverage container 20, or at least an outer wall 301 thereof, and the bottle opener 30 may be composed of a similar or the same material for functional and aesthetic reasons.

As shown in FIG. 3B, the bottle opener 30 may be slidingly received in the receiving slot 615 of the top side of the lid surface 402 so that the proximal end 35 of the bottle opener 30 covers the port 610. The bottle opener 30 may cover the port 610 and reduce or restrict the exit of a liquid therethrough. According to certain aspects of the invention, the bottle opener 30 may also seal the port 610 to substantially stop the flow of liquid therethrough. That is, the port 610 may also include a lip or other means (not shown) to provide a seal between the bottle opener 30, such as along an underside, and the port 610. The seal may be liquid tight.

With specific reference to FIGS. 4A and 6B, the bottle opener 30 may have a proximal end 35 and a distal end 34. The bottle opener 30 may be generally rectangular in shape, having a longitudinal axis that runs between the proximal and distal ends (35 and 34, respectively). Further, the bottle opener 30 may include an opening 32 which is sized and shaped to open a cap of a bottle.

According to certain aspects of the invention, the bottle opener 30 may be substantially flat, or may be curved as shown in the figures. For example, in the figures, a small portion of the bottle opener 30 near the proximal end 34 may be curved upward away from the lid surface 402 when the bottle opener 30 is installed thereon. That is, a portion of the bottle opener 30 which includes the proximal end 34 and at least a part of the opening 32 may be curved and angled upward such as, for example, at an angle greater than 10 degrees but less than 90 degrees (wherein 90 degrees upward is defined relative to the longitudinal axis and would be perpendicular to the longitudinal axis). While the curve is shown to be located in only a portion of the proximal end of the bottle opener, a greater portion of the bottle opener 30, which may include the proximal end 34 and all of the opening 32, may be curved.

The opening 32 of the bottle opener 20 may comprise a first transverse wall 42 adjacent the distal end 34 of the opener, side walls (44 and 46), and an inwardly directed arcuately shaped second transverse wall 36 protruding towards the opposite wall (first transverse wall 42). The bottle opener 30 may be used in a conventional manner to remove a pry-off cap from a bottle. For example, the opening 32 may be placed on the bottle cap so that the first transverse wall 42 rests on top of the bottle cap and the protruding arcuate second transverse wall 36 is positioned under the crimped-down edge of the bottle cap. The proximal end 35 of the bottle opener 30 may then be lifted to provide a lever action so that the protruding arcuate second transverse wall 36 pries off the bottle cap. Alternatively, the bottle opener 30 may be used to open a tab on a can, such as a pull-tab or a stay-on-tab. For example, the opening 32 may be placed on a top of the can so that the first transverse wall 42 rests on top of the tab and the protruding arcuate second transverse wall 36 is positioned under the tab. The proximal end 35 of the bottle opener 30 may then be lifted to provide a lever action so that the protruding arcuate second transverse wall 36 pulls the tab up to open the can.

While a single opening 32 is shown in the bottle opener 30, alternate or additional openings and/or “hooks” may be included to facilitate opening of other type of bottles and cans. For example, an off-set hook may be included on an end of the bottle opener 30, such as the distal end 34, wherein the hook may be inserted into the ring-like portion of a tab on a can. The proximal end 35 of the bottle opener 30 may then be lifted to provide a lever action so that the hook lifts the tab to open the can.

Further, while only a single transverse wall of the opening 32 of the bottle opener 30 is described as protruding or arcuate (the second transverse wall 36), the first transverse wall 42 may also by arcuate and protrude inwardly toward the center of the opening 32 (toward the second transverse wall 36).

The bottle opener 30 may be removeably connected to the lid 10 by sliding the opener into the receiving slot 615 on the top side 402 of the lid 10. The receiving slot 615 may by sized to accept the bottle opener 30, and may include means to hold the bottle opener 30 in place, and/or guide the bottle opener 30 along a path that spans the area between the drinking port 610 and the lip 212 (parallel with the longitudinal axis 620 of the receiving slot 615).

Exemplary means to removeably hold the bottle opener 30 within the receiving slot 615 on the lid 10 include at least tabs and/or longitudinal grooves. As shown in FIG. 6A, the top side 402 of the lid surface may include one or more sets of transverse tabs (602A, 602B) that may extend perpendicularly to the longitudinal axis 620 of the receiving slot 615. These transverse tabs (602A, 602B) may be spaced from a bottom surface of the receiving slot 615 at a distance that allows the bottle opener 30 to slide beneath the transverse tabs within the receiving slot 615. For example, the transverse tabs (602A, 602B) may be spaced at a distance from the bottom surface of the receiving slot 615 that is approximately equal to, or just slightly larger than, the thickness of the bottle opener 30. The transverse tabs (602A, 602B) may be matched (i.e., extend from opposing lateral edges of the receiving slot as shown in FIG. 6A), or may be offset.

Rather than transverse tabs, the bottle opener 30 may be removeably held within the receiving slot 615 by a set of matched grooves which extend along the sides of the receiving slot 615. As discussed above with respect to the transverse tabs, the grooves may be spaced at a distance from the bottom surface of the receiving slot 615 that is approximately equal to, or just slightly larger than, the thickness of the bottle opener 30.

With reference to FIGS. 6A and 6B, the lid 10 may also include a positioning tab 612 which projects upwardly from (perpendicular to) the top surface 402. A portion or end of the positioning tab 612 may be sized and configured to interact with an indent (51, 52) on a side of the bottle opener 30. These indents may be included on the side on the bottle opener 30 which faces the top surface 402 of the lid 10, such as a bottom side of the bottle opener 30, or may be included on both sides of the bottle opener 30.

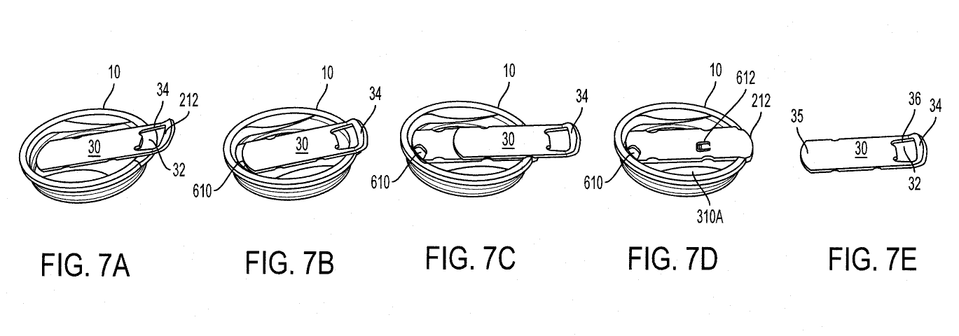

As the bottle opener is positioned within the receiving slot 615, a first indent 51, or a second indent 52, may interact with the positioning tab 612 to temporarily stop or hold the bottle opener at a specific position within the receiving slot 615. The positioning tab 612 may be somewhat resilient, and may therefore be deflectable downwardly when sufficient force is applied. This accommodates movement of the bottle opener 30 between a closed position (FIG. 7A), a partially open position (FIG. 7B), a fully open position (FIG. 7C), and fully removed (FIGS. 7D and 7E), as discussed in more detail below.

As indicated above, the bottle opener 30 may be substantially flat, or may be curved as shown in the figures, such that an end 34 near the opening 32 may be curved upward and away from the lid 10 when installed within the receiving slot 615 thereon. Such an upward curvature may enhance the ease of removal of the bottle opener 30 from the receiving slot 615, such as by providing a raised edge for a user to grasp, and/or may ensure that the bottom surface of the bottle opener 30, which includes the first and second indents (51 and 52), faces toward the top surface of the lid 10. This may ensure that the first and second indents (51 and 52) may become engaged with the positioning tab 612 as the bottle opener 30 is slidingly received within the receiving slot 615.

FIGS. 7A-7E illustrate a sequence of steps in the removal (FIG. 7A to 7E), or insertion (FIG. 7E to 7A) of the bottle opener 30 within the receiving slot 615 on the lid 10. The bottle opener 30 is shown as fully received within the receiving slot in FIG. 7A. The proximal end (35, see FIG. 6B) of the bottle opener 30 is positioned at or proximal to an inner surface of the circumferential wall 504, and covers the drinking port (610, see FIG. 6A). With the bottle opener 30 covering the drinking port 610, liquids may be deterred from passing through the port 610 (such as a beverage contained in a beverage container onto which the lid in installed).

As shown in FIG. 7B, the bottle opener 30 may slide within the receiving slot 615 to a position which opens the drinking port 610. A user may grasp a distal end 34 of the bottle opener 30, such as within the opening 32, and may slide the bottle opener 30 away from the drinking port 610 along the longitudinal axis 620 of the receiving slot 615, until the positioning tab 612 interacts with the second positioning indent 52. This provides free access to the drinking port 610, but leaves the bottle opener 30 in a secure position on the lid 10.

The bottle opener 30 may slide further along the longitudinal axis 620 of the receiving slot 615, until the positioning tab 612 interacts with the first positioning indent 51. In this position, as shown in FIG. 7C, the opening 32 of the bottle opener 30 may be fully exposed. In such a position, the bottle opener 30 may be used to open a cap or tab from a bottle or can while the opener is still in a secure position on the lid 10.

Alternatively, the bottle opener 30 may slide entirely out of the receiving slot 615, as shown in FIG. 7D, which illustrates the lid 10 with the bottle opener 30 removed, and FIG. 7E, which illustrates the bottle opener 30 fully removed from the lid 10. The lid 10 with the bottle opener 30 removed still functions, when installed on an open end of a beverage container (such as beverage container 20 shown in FIG. 1), to hold the liquid within the container, and allows a user to drink from the container. The bottle opener 30 may be used to open one or more bottles or cans, and may be replaced within the receiving slot 615 on the lid 10. The sequence of steps for slideably inserting the bottle opener 30 within the receiving slot 615 are the same, but in reverse order, as the steps described above for removing the bottle opener 30 from the receiving slot 615.

The lid 10 may detachably connect to an open mouth of a beverage container, such as the open top end 28 of the beverage container 20 shown in FIG. 3A. Such connection may form a liquid-tight seal. The connection may include contact between an outer surface of the top region 22 of the beverage container 20 and an inner surface of the circumferential wall 504 of the lid 10. Alternatively, the connection may include contact between an inner surface of the top region 22 of the beverage container 20 and an outer surface of the circumferential wall 504 of the lid 10. The connection may be facilitated by matching threads on each surface, such as screw threads, or by matching protrusions and indents, which may include resilient gaskets. Any number of means for connecting a lid to a container are known in the art and are within the scope of the presently disclosed invention.

One such means of connection is shown in the cross-sectional view of FIG. 2B, wherein the beverage container 20 includes an inner sidewall 302, an outer sidewall 301, an open top end 28, and a closed bottom end 26. An upper region 22 of the beverage container 20 may be adapted to engage a portion, such as the base portion 503, of the circumferential wall 504 of the lid 10. As shown, the inner sidewall 302 of the beverage container 20 may include an indent 304 which creates an area at the top end 22 of the beverage container 20 that may accept the base portion 503 of the lid 10 therein. Further, the base portion 503 of the circumferential wall 504 may include a threaded, ridged, or indented portion that may provide a liquid tight seal with the upper region 22 of the beverage container 20.

The base portion 503 of the lid 10 may further include a resilient gasket (not shown) that resides within an indent thereon, the gasket forming a liquid tight seal between the inner surface of the top region 22 of the beverage container 20 and the outer surface of the circumferential wall 504 of the lid 10.

Each of the characteristics and exemplary embodiments described above, and combinations thereof, may be said to be encompassed by the present invention. The present invention is thus drawn to the following non-limiting aspects:

(1) An integrated lid for a beverage container, the lid comprising: a removable bottle opener having a proximal end, a distal end, and a longitudinal axis therebetween, the bottle opener comprising an opening at the distal end which is sized and shaped to open a cap of a bottle; and a lid comprising: a lid surface having a top side which comprises a receiving slot configured to receive the bottle opener, the receiving slot having a longitudinal axis which aligns with the longitudinal axis of the bottle opener when the bottle opener is received therein, a circumferential wall surrounding the lid surface, the circumferential wall having a top portion and a base portion, the base portion configured to sealingly engage with an open end of a beverage container, and a port which passes from the top side of the lid surface to a bottom side of the lid surface, wherein the port is of a size and shape appropriate for passage of a liquid and is positioned proximal to the circumferential wall of the lid within the receiving slot, wherein the bottle opener is slidingly received in the receiving slot of the top side of the lid surface so that the proximal end of the bottle opener covers the port and stops passage of the liquid therethrough.

(2) The integrated lid according to aspect 1, wherein the top portion of the circumferential wall comprises a lip which extends upwardly from the lid surface.

(3) The integrated lid according to aspect 2, wherein the lid surface is downwardly angled with respect to the circumferential wall so that the lip extends upwardly from a side of the lid comprising the port to a greater extent than from a side of the lid opposite from the port.

(4) The integrated lid according to any of aspects 1 to 3, wherein the base portion of the circumferential wall comprises a sealing means on an inner surface or on an outer surface, wherein the sealing means comprises a threaded region matching a threaded region on an adjacent surface of the open mouth of the beverage container.

(5) The integrated lid according to any of aspects 1 to 3, wherein the base portion of the circumferential wall comprises a sealing means on an inner surface or on an outer surface, wherein the sealing means comprises a groove or protrusion matching a protrusion or groove, respectively, on an adjacent surface of the open mouth of the beverage container.

(6) The integrated lid according to any of aspects 1 to 3, wherein when the sealing means is a groove on the base portion of the circumferential wall, the sealing means further comprising an elastomeric gasket which fits within the groove.

(7) The integrated lid according to any of aspects 1 to 6, wherein the bottle opener is held within the receiving slot on the lid surface by a set of indented grooves.

(8) The integrated lid according to any of aspects 1 to 7, wherein the bottle opener is held within the receiving slot on the lid surface by one or more sets of tabs which extend from opposing lateral edges of the receiving slot.

(9) The integrated lid according to any of aspects 1 to 8, wherein the bottle opener comprises an indent that interacts with a positioning tab on a top side of the lid surface within the receiving slot to secure the bottle opener in a set position.

(10) The integrated lid according to any of aspects 1 to 9, wherein the bottle opener is substantially composed of a metal material.

(11) The integrated lid according to any of aspects 1 to 10, wherein the lid is substantially composed of a polymeric material.

(12) A beverage container comprising a beverage receptacle having an open top end including a rim, and a closed bottom end; the integrated lid according to any of aspects 1 to 11.

(13) The beverage container according to aspect 12, wherein the beverage receptacle and the bottle opener are substantially composed of a metal material.

(14) The beverage container according to aspects 12 or 13, wherein the beverage receptacle and the bottle opener are substantially composed of the same material.

(15) The beverage container according to any of aspect 12 to 14, wherein the beverage receptacle is thermally insulated.

While specific embodiments of the invention have been described in detail, it should be appreciated by those skilled in the art that various modifications and alternations and applications could be developed in light of the overall teachings of the disclosure. Accordingly, the particular arrangements, systems, apparatuses, and methods disclosed are meant to be illustrative only and not limiting as to the scope of the invention.

What is claimed is:

1. An integrated lid for a beverage container, the lid comprising:
a removable bottle opener having a proximal end, a distal end, and a longitudinal axis therebetween, the bottle opener comprising an opening at the distal end which is sized and shaped to open a cap of a bottle; and
a lid comprising:
a lid surface having a top side which comprises a receiving slot configured to receive the bottle opener, the receiving slot having a longitudinal axis which aligns with the longitudinal axis of the bottle opener when the bottle opener is received therein,
a circumferential wall surrounding the lid surface, the circumferential wall having a top portion and a base portion, the base portion configured to sealingly engage with an open end of a beverage container, and
a port which passes from the top side of the lid surface to a bottom side of the lid surface, wherein the port is of a size and shape appropriate for passage of a liquid and is positioned proximal to the circumferential wall of the lid within the receiving slot,
wherein the bottle opener is slidingly received in the receiving slot of the top side of the lid surface so that the proximal end of the bottle opener covers the port and stops passage of the liquid therethrough.

2. The integrated lid of claim 1, wherein the top portion of the circumferential wall comprises a lip which extends upwardly from the lid surface.

3. The integrated lid of claim 2, wherein the lid surface is downwardly angled with respect to the circumferential wall so that the lip extends upwardly from a side of the lid comprising the port to a greater extent than from a side of the lid opposite from the port.

4. The integrated lid of claim 1, wherein the base portion of the circumferential wall comprises a sealing means on an inner surface or on an outer surface, wherein the sealing means comprises a threaded region.

5. The integrated lid of claim 1, wherein the base portion of the circumferential wall comprises a sealing means on an inner surface or on an outer surface, wherein the sealing means comprises a groove.

6. The integrated lid of claim 5, wherein the sealing means further comprises an elastomeric gasket which fits within the groove.

7. The integrated lid of claim 1, wherein the bottle opener is held within the receiving slot on the lid surface by a set of indented grooves.

8. The integrated lid of claim 1, wherein the bottle opener is held within the receiving slot on the lid surface by one or more sets of tabs which extend from opposing lateral edges of the receiving slot.

9. The integrated lid of claim 1, wherein the bottle opener comprises an indent that interacts with a positioning tab on a top side of the lid surface within the receiving slot to secure the bottle opener in a set position.

10. The integrated lid of claim 1, wherein the bottle opener is substantially composed of a metal material.

11. The integrated lid of claim 1, wherein the lid is substantially composed of a polymeric material.

12. A beverage container comprising:
a beverage receptacle comprising an open top end including a rim, and a closed bottom end; and
an integrated lid comprising:
a removable bottle opener having a proximal end, a distal end, and a longitudinal axis therebetween, the bottle opener comprising an opening at the distal end which is sized and shaped to open a cap of a bottle; and
a lid comprising:
a lid surface having atop side which comprises a receiving slot configured to receive the bottle opener, the receiving slot having a longitudinal axis which aligns with the longitudinal axis of the bottle opener when the bottle opener is received therein,
a circumferential wall surrounding the lid surface, the circumferential wall having a top portion and a base portion, the base portion configured to sealingly engage with the rim of the beverage receptacle, and
a port which passes from the top side of the lid surface to a bottom side of the lid surface, wherein the port is of a size and shape appropriate for passage of a liquid and is positioned proximal to the circumferential wall of the lid within the receiving slot,
wherein the bottle opener is slidingly received in the receiving slot of the top side of the lid surface so that the proximal end of the bottle opener covers the port and stops passage of the liquid therethrough.

13. The beverage container of claim 12, wherein the top portion of the circumferential wall comprises a lip which extends upwardly from the lid surface.

14. The beverage container of claim 13, wherein the lid surface is downwardly angled with respect to the circumferential wall so that the lip extends upwardly from a side of the lid comprising the port to a greater extent than from a side of the lid opposite from the port.

15. The beverage container of claim 12, wherein the bottle opener is held within the receiving slot on the lid surface by one or more sets of tabs which extend from opposing lateral edges of the receiving slot.

16. The beverage container of claim 12, wherein the bottle opener comprises an indent that interacts with a positioning tab on a top side of the lid surface within the receiving slot to secure the bottle opener in a set position.

17. The beverage container of claim 12, wherein the beverage receptacle and the bottle opener are substantially composed of a metal material.

18. The beverage container of claim 12, wherein the beverage receptacle and the bottle opener are substantially composed of the same material.

19. The beverage container of claim 12, wherein the lid is substantially composed of a polymeric material.

20. The beverage container of claim 12, wherein the beverage receptacle is thermally insulated.
